(19) United States
(12) Patent Application Publication
(10) Pub. No.: US 2017/0023695 A1
(43) Pub. Date: Jan. 26, 2017

(54) GENERATOR FOR LATEROLOG TOOL

(71) Applicant: HALLIBURTON ENERGY SERVICES INC., Houston, TX (US)

(72) Inventors: Xiaochong Zhang, Singapore (SG); Kuo Hwi Roy Tan, Singapore (SG); Alberto Quintero, Singapore (SG)

(21) Appl. No.: 14/424,891

(22) PCT Filed: Apr. 14, 2014
(86) PCT No.: PCT/US2014/034026

§ 371 Date: Feb. 27, 2015

(51) Int. Cl. G01V 3/24; E21B 47/12; E21B 49/00

(52) U.S. Cl. CPC G01V 3/24; E21B 49/003; E21B 47/12

(57) ABSTRACT

A method and apparatus for generating a low distortion sinusoidal signal with controllable amplitude for use with downhole tools, such as an array laterolog. In preferred embodiment, a signal-generating digital-to-analog converter is provided to produce a sinusoidal or other waveform at full scale. An amplitude-controlling digital-to-analog converter provides a voltage reference for the signal-generating digital-to-analog converter. The tandem combination of two digital-to-analog converters allows the generation of low distortion signals, even at low amplitudes. The amplitude-controlling digital-to-analog converter is provided digital codes by the downhole tool system processor. A high-speed dedicated controller provides digital codes to the signal-generating digital-to-analog converter, which relieves the system processor from the intensive task of providing signal generating codes, thereby freeing processor bandwidth for other system tasks.

### TECHNICAL FIELD

The present disclosure relates generally to oilfield equipment, and in particular to logging tools.

### BACKGROUND

Numerous downhole logging operations in oil wells require the transmission of excitation signals into the well environment with the objective of determining the characteristics of the geological formations. An array laterolog tool is one such tool. This tool has multiple electrodes for emitting and focusing currents into the formation. Each emitting electrode requires a driving signal, typically a precise, low-frequency (hundreds or thousands of cycles per second) AC signal, that is used to generate these currents. Each driving signal typically consists of either a single low-frequency sinusoid signal or a combination of several sinusoid signals of different frequencies.

For accurate measurements, frequencies and amplitudes of these signals must be controlled with high precision, and the signals must be characterized by low harmonic distortion. The technical challenge of generating an appropriate driving signal is compounded by the fact that the system is required to maintain focused current at both very low and very high formation resistivity and under high temperature conditions.

There are several common systems to generate sinusoidal signals: (1) sinusoidal oscillator; (2) a crystal oscillator to generate a square wave, with the square wave filtered by a band-pass filter (BPF); and (3) a single digital-to-analog converter (DAC).

A sinusoidal oscillator is the most direct way of generating a sine wave. However, to generate a high-precision sinusoidal signal at a frequency suitable for use in a laterolog tool, a low-frequency crystal is required, and such crystals are not readily available. A sinusoidal oscillator also suffers a disadvantage in maintaining performance across a wide range of temperatures.

A crystal oscillator may be used to generate a square wave, which may be divided to a desired frequency and filtered by a BPF to remove harmonic components. However, the filtering process is imperfect, and as a result the sinusoid signal is still characterized by relatively high levels of distortion.

More recently, the use of a single DAC to generate a sinusoidal signal has become a common technique. The desired sinusoidal signal is approximated by a series of digital codes which are sequentially sent to the DAC by a computer processor or other digital logic circuitry. The resulting output signal of the DAC is filtered by a low-pass filter (LPF) to remove the high-frequency clock artifice. In order to produce a sinusoidal signal with suitable resolution for use with a laterolog tool, a high sampling frequency (up to 100 kHz) is necessary, resulting in a heavy processor load and concomitant narrow remaining processor bandwidth for other system functions, such as data processing and communications. Also, because of a limited dynamic range of a DAC, when the required amplitude of the output is too low, the distortion becomes high. For example, with a 1 mV output, the distortion of a sinusoidal signal may reach 10%. As array laterolog tools must occasionally operate with the signal amplitude in the millivolt range, this characteristic is not ideal.

Accordingly, a better method and system to generate a low-distortion, variable amplitude sinusoid signal that is suitable for array laterolog tool applications, without the drawbacks of traditional signal-generation methods, is desirable.

### BRIEF DESCRIPTION OF THE DRAWINGS

Embodiments are described in detail hereinafter with reference to the accompanying figures, in which:

FIG. 1 is a block-level schematic diagram of a well logging system according to an embodiment, showing a logging tool suspended by wireline in a well and incorporating the sinusoidal generator of FIG. 3;

FIG. 2 is a block-level schematic diagram of a logging while drilling system according to an embodiment, showing a drill string and a drill bit for drilling a bore in the earth and a logging tool disposed in a drill string incorporating the sinusoidal generator of FIG. 3;

FIG. 3 is a block-level schematic diagram of a sinusoidal signal generator for use within a downhole tool according to a present embodiment, showing a dual tandem arrangement of digital-to-analog converters; and

FIG. 4 is an upper level flow chart diagram of a method according to a preferred embodiment for providing a signal to an electrode having a user-selectable frequency using a first DAC, showing the step of controlling the amplitude of the signal by controlling the reference level of the first DAC using a second DAC.

### DETAILED DESCRIPTION

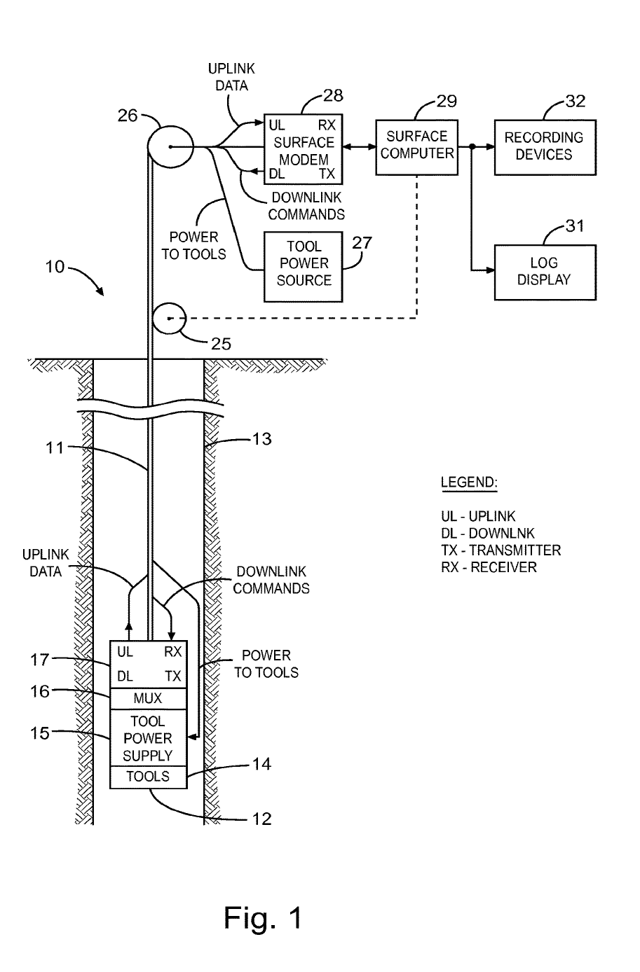

FIG. 1 shows a system view of a well logging apparatus of the present disclosure. The apparatus shown in FIG. 1 is identified by the numeral 10 which generally refers to a well logging system.

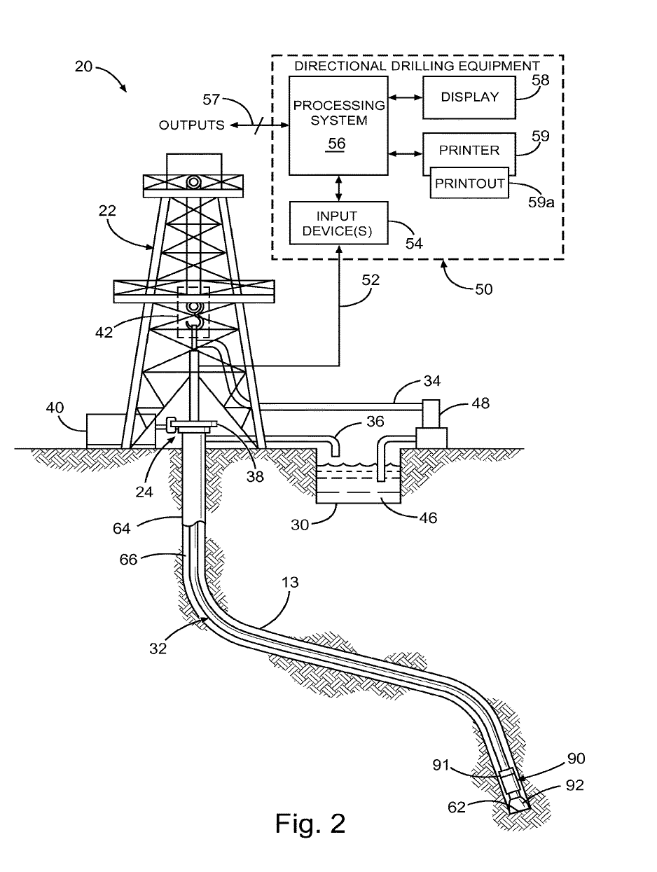

A logging cable 11 suspends a sonde 12 in a wellbore 13. The wellbore 13 may drilled by a drill bit on a drill string as illustrated in FIG. 2, and the wellbore 13 may be uncased or lined with casing. The wellbore 13 can be any depth, and the length of the logging cable 11 is sufficient for the depth of wellbore 13.

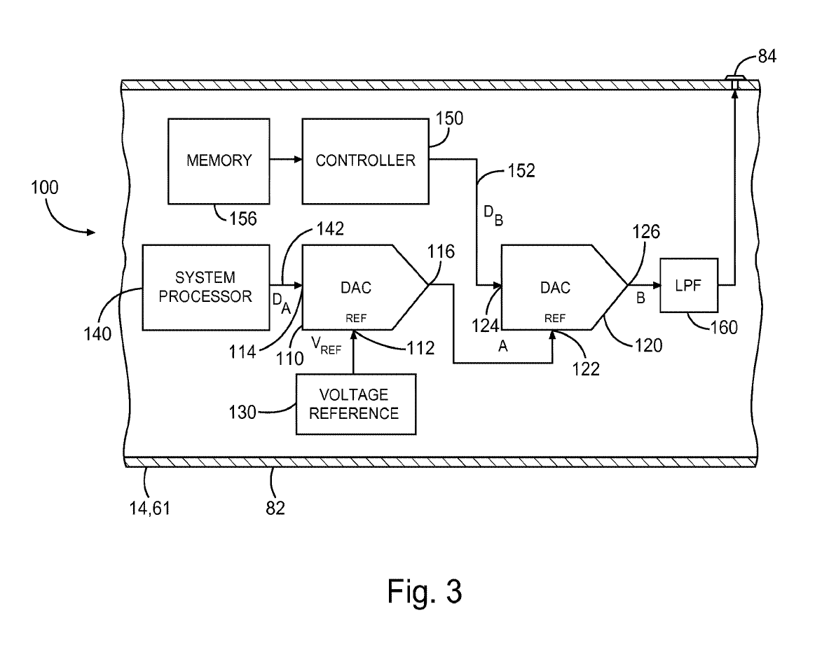

The sonde 12 generally has a protective shell or housing which is fluid tight and pressure resistant and which enables the equipment on the interior to be supported and protected during deployment. The sonde 12 encloses one or more logging tools 14 which generate data useful in analysis of the wellbore 13 or in determining the nature of the formations which are adjacent to the wellbore 13. In one embodiment, tool 14 may be a laterolog which has a sinusoidal generator as described below with respect to FIG. 3.

Other types of tools may be included in sonde 12, for example to test the nature of the lining in the wellbore 13 or the quality of the bond between the cement on the exterior of the wellbore casing. The sonde 12 may also enclose a power supply 15.

If two or more tools 14 are included in sonde 12 output data streams from the multiple tools may be provided to a multiplexer 16 located in the sonde 12. The sonde 12 may also include a communication module 17 having an uplink communication device, a downlink communication device, a data transmitter, and a data receiver.

Logging system 10 includes a sheave 25 which is utilized in guiding the logging cable 11 into the well. The cable 11 is spooled on a cable reel 26 or drum for storage. The cable on the reel connects with the sonde 12 and is spooled out or spooled in to raise and lower the sonde 12 in the well borehole.

Conductors in cable 11 connect with surface-located equipment, which may include a DC power source 27 to provide power to the tool power supply 15, a surface communication module 28 having an uplink communication device, a downlink communication device, a data transmitter and also a data receiver, a surface computer 29, a logging display 31 and one or more recording devices 32. Sheave 25 may be connected by a suitable means to an input to surface computer 29 to provide sonde depth measuring information. The surface computer 29 provides an output for a logging display 31 and a recording device 32. The surface logging system 10 forms output data as a function of depth. The recorders are incorporated to make a record of the data as a function of depth in the well.

FIG. 2 illustrates a system view of a measurement while drilling (MWD) or logging while drilling (LWD) apparatus of the present disclosure. The apparatus shown in FIG. 2 is identified by the numeral 20 which generally refers to drilling system.

LWD system 20 may include land drilling rig 22. However, teachings of the present disclosure may be satisfactorily used in association with offshore platforms, semi-submersible, drill ships and any other drilling system satisfactory for forming a wellbore 13 extending through one or more downhole formations.

Drilling rig 22 and associated control system 50 may be located proximate well head 24. Drilling rig 22 generally also includes rotary table 38, rotary drive motor 40 and other equipment associated with rotation of drill string 32 within wellbore 13. Annulus 66 is formed between the exterior of drill string 32 and the inside diameter of wellbore 13.

For some applications drilling rig 22 may also include top drive motor or top drive unit 42. Blow out preventers (not expressly shown) and other equipment associated with drilling a wellbore 13 may also be provided at well head 24. One or more pumps 48 may be used to pump drilling fluid 46 from fluid reservoir or pit 30 to one end of drill string 32 extending from well head 24. Conduit 34 may be used to supply drilling fluid from pump 48 to the end of drilling string 32 extending from well head 24. Conduit 36 may be used to return drilling fluid, reservoir fluids, formation cuttings and/or downhole debris from the bottom or end 62 of wellbore 13 to fluid reservoir or pit 30. Various types of pipes, tube and/or conduits may be used to form conduits 34 and 36.

Drill string 32 may extend from well head 24 and may be coupled with a supply of drilling fluid, such as pit or reservoir 30. The opposite end of drill string 32 may include bottom hole assembly 90 having a rotary drill bit 92 disposed adjacent to end 62 of wellbore 13. Bottom hole assembly 90 may also include bit subs, mud motors, stabilizers, drill collars, or similar equipment. Rotary drill bit 92 may include one or more fluid flow passageways with respective nozzles disposed therein. Various types of drilling fluids 46 may be pumped from reservoir 30 through pump 48 and conduit 34 to the end of drill string 32 extending from well head 24. The drilling fluid 46 may flow through a longitudinal bore (not expressly shown) of drill string 32 and exit from nozzles formed in rotary drill bit 92.

At end 62 of wellbore 13 drilling fluid 46 may mix with formation cuttings and other downhole fluids and debris proximate drill bit 92. The drilling fluid will then flow upwardly through annulus 66 to return formation cuttings and other downhole debris to well head 24. Conduit 36 may return the drilling fluid to reservoir 30. Various types of screens, filters and/or centrifuges (not expressly shown) may be provided to remove formation cuttings and other downhole debris prior to returning drilling fluid to pit 30.

Bottom hole assembly 90 may also include various tools 91 that provide logging or measurement data and other information about wellbore 13. This data and information may be monitored by a control system 50. In particular, bottom hole assembly 90 includes a tool 91 having a sinusoidal generator as described below with respect to FIG. 3, which in an embodiment may be a laterolog tool. However other various types of MWD or LWD tools may be included in bottom hole assembly 90 as appropriate.

Measurement data and other information may be communicated from end 62 of wellbore 13 through fluid within drill string 32 or the annulus using MWD techniques and converted to electrical signals at well surface 24. Electrical conduit or wires 52 may communicate the electrical signals to input device 54. The measurement data provided from input device 54 may then be directed to a data processing system 56. Various displays 58 may be provided as part of control system 50.

For some applications printer 59 and associated printouts 59 may also be used to monitor the performance of drilling string 32, bottom hole assembly 90 and associated rotary drill bit 100. Outputs 57 may be communicated to various components associated with operating drilling rig 22 and may also be communicated to various remote locations to monitor the performance of drilling system 20.

A block diagram of a signal generator 100 for use with a laterolog or similar downhole tool 14 or LWD tool 91 according to a preferred embodiment is shown in FIG. 3. Tool 14, 91 includes a housing 82 with at least one electrode 84. Generator 100 is located within housing 82 and includes two digital-to-analog converters (DAC) connected in tandem, namely, an amplitude-controlling DAC 110 and a signal- or sinusoid-generating DAC 120. Control circuitry is coupled to the digital inputs of DACs 110, 120, as discussed below.

As is known in the art, a typical DAC has a digital input, a reference input, and an analog output, and it requires digital input code, an analog reference voltage, and a clock signal. The digital code is received at a digital input via a serial peripheral interface (SPI) or similar electrical bus. The DAC produces a voltage or current signal at its output that corresponds to the digital code received at the digital input, scaled by the analog reference voltage. The analog output signal is quantized at the clock signal frequency at a resolution determined by the number of bits in the DAC circuitry.

The analog reference voltage input 112 of DAC 110 is connected to a precision voltage reference chip 130 having an output voltage of V_{ref}. The digital input 114 of DAC 110 receives its code via a SPI or similar bus 142 from a system processor 140. System processor 140 may be a microprocessor, microcontroller, or a specialized processor such as a digital signal processor, for example. In a preferred embodiment, processor 140 is the system processor for a laterolog tool, and it performs other processing and communications functions for the tool in addition to providing the digital input for DAC 110.

The output signal A of amplitude-controlling DAC 110 is given by Equation 1:

$$A = \frac{{D}_{A}}{{2}^{n}} {V}_{ref} \qquad ( Equation 1 )$$

where n is the resolution of DAC 110 in bits, D_{A} is the decimal equivalent of the binary code loaded to the register of DAC 110, which may range from 0 to 2ⁿ−1, and V_{ref} is a static analog reference voltage provided by voltage reference chip 130.

The minimum step change of amplitude is determined by the least significant bit of DAC 110. For an exemplar 14-bit DAC and 2.5V reference voltage, the minimum step is approximately 152 μV, which is adequate for the precise hardware focusing requirements of a laterolog tool.

The analog reference voltage input 122 of DAC 120 is connected to the output 116 of DAC 110. The digital input 124 of DAC 120 preferably receives its code via a SPI or similar bus 152 from a dedicated controller 150. Dedicated controller 150 may be a microprocessor, microcontroller, or a specialized processor such as a field programmable gate array (FPGA) or application specific integrated circuit (ASIC), for example, which is preferably discrete from and operates independently of system processor 140.

The output signal B of amplitude-controlling DAC 120 is given by Equation 2:

$$B = \frac{{D}_{B}}{{2}^{m}} A = \frac{{D}_{A} {D}_{B}}{{2}^{n} {2}^{m}} {V}_{ref} \qquad ( Equation 2 )$$

where m is the resolution of DAC 120 in bits, and D_{B} is the decimal equivalent of the binary code loaded to the register of DAC 120, which may range from 0 to 2^{m}−1.

Given a clock or sampling rate of c samples/second for DAC 120, controller 150 is preferably arranged to provide a digital input code D_{B} so as to produce a sine wave of frequency f, as follows:

$${D}_{B} = ( {2}^{m} - 1 ) sin ( 2 π \frac{l}{L} ) \qquad ( Equation 3 )$$

where L is the number of samples per sine wave cycle, l is the sequential sample number, and

$$f = \frac{c}{L} .$$

Ideally, the clock or sampling frequency c of DAC 120 is about at least 1000 times higher than the sinusoid signal frequency f (i.e., hundreds of kHz versus hundreds of Hz).

However, in other embodiments, controller 150 may be arranged to generate a D_{B} that represents a superposition of several sinusoid signals or even non-sinusoidal and arbitrary signals, as desired.

Dedicated controller 150 may also be in communication with a memory 156, which may contain one or more look-up tables for enabling processor 150 to generate the D_{R} codes used for DAC 120.

Typically, the clock or sampling frequency c is significantly higher than the sinusoid signal frequency f. Accordingly, the analog output 126 of sine-wave-generating DAC 120 may be connected to a low-pass-filter 160 to remove any clock components or harmonics from the output signal B.

In array laterolog tools, the signal amplitude may need adjustment periodically, depending on the focusing condition. If the focusing condition is satisfied, the signal amplitude remains constant, and amplitude-controlling DAC 110 does not need updating. When the focusing condition requires the signal amplitude to be changed, only a modicum of the available bandwidth of processor 140 is required to latch an updated code D_{A} into the register of DAC 110. Furthermore, because dedicated controller 150 provides the sinusoidal signal-generating codes D_{B} at high speeds (up to 100 kHz) for DAC 120, the system processor 140 is free to perform other operations like data processing and communications.

The distortion of the output signal depends solely on sinusoid-generating DAC 120. Because DAC 120 always operates at full-scale, the distortion performance is the same even when the signal level is as low as in the millivolt range. For example, for a 14-bit DAC and 100 kHz sample rate, a sinusoid signal of a frequency of hundreds of Hz can be generated with a distortion less than 0.1%.

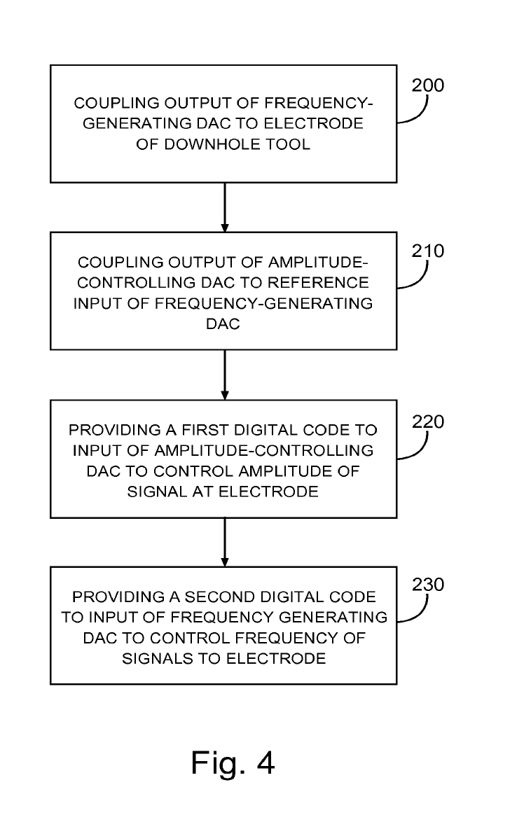

FIG. 4 illustrates a method of providing an output signal to an electrode of a downhole tool, for example. In step 200, a first DAC—a frequency-generating DAC—is provided, and its output is electrically coupled to the electrode, which may be via a low pass filter. In step 210, a second DAC—an amplitude controlling DAC—is provided, and its output is connected to the reference input of the frequency-generating DAC. Then a first output from the frequency-generating DAC is provided to an electrode while a second output from the amplitude controlling DAC is provided to the frequency-generating DAC.

At step 220, a first digital code is provided at the input of the amplitude-controlling DAC. This input sets the amplitude of the signal that is output at the electrode, and it may be generated by a system processor or other logic circuit. At step 230, a second digital code is input to the input of the frequency-generating DAC, which controls the frequency and waveform shape output at the electrode. The second digital code may be stored in a memory and be selected by a controller. However, other digital logic circuits may be used as appropriate. Steps 220 and 230 may occur in either order, or at the same time. In this manner, a signal characterized by a selectable frequency and a selectable amplitude is generated and output at the electrode.

In summary, a downhole tool and system utilizing a sinusoidal generator and a method for generating a sinusoidal signal have been described. Embodiments of the downhole tool may generally have a housing having an electrode, first and second digital-to-analog converters disposed in the housing and each having a digital input, a reference input, and an analog output, the analog output of the first digital-to-analog converter being operatively coupled to the reference input of the second digital-to-analog converter, the analog output of the second digital-to-analog converter being operatively coupled to the electrode, and control circuitry coupled to the digital inputs of the first and second digital-to-analog converters. Embodiments of the system may generally have first and second digital-to-analog converters disposed in the housing, each the digital-to-analog converter having a digital input, a reference input, and an analog output, the analog output of the first digital-to-analog converter being operatively coupled to the reference input of the second digital-to-analog converter, a controller coupled to the digital input of the second digital-to-analog converter for determining a frequency and a shape of a waveform characterizing a signal produced by the second digital-to-analog converter, and a processor coupled to the digital input of the first digital-to-analog converter for controlling a voltage applied to the reference input of the second digital-to-analog converter thereby controlling the amplitude of the waveform. Finally, embodiments of the method for generating a sinusoidal signal may generally include providing a downhole tool having first and second digital-to-analog converters, each digital-to-analog converter having a digital input, a reference input, and an analog output, the analog output of the first digital-to-analog converter being operatively coupled to the reference input of the second digital-to-analog converter, and providing digital codes to the digital inputs of the first and second digital-to-analog converters to generate a signal characterized by a selectable frequency and a selectable amplitude.

Any of the foregoing embodiments may include any one of the following elements or characteristics, alone or in combination with each other: The control circuitry includes a controller coupled to the digital input of the second digital-to-analog converter for determining a frequency and a shape of a waveform characterizing a signal produced by the second digital-to-analog converter; the control circuitry includes a processor coupled to the digital input of the first digital-to-analog converter for controlling a voltage applied to the reference input of the second digital-to-analog converter thereby controlling the amplitude of the waveform; the controller is arranged to produce a sinusoidal waveform; a low pass filter coupled between the analog output of the second digital-to-analog converter and the electrode; the downhole tool is a laterolog tool; the controller is independent of the processor; a low pass filter operatively coupled to the analog output of the second digital-to-analog converter; a drill string; a drill bit disposed at the end of the drill string; at least one measurement tool carried by the drill string, the measurement tool having at least one electrode operatively coupled to the analog output of the second digital-to-analog converter; a logging cable; a sonde attached to the logging cable; at least one measurement tool disposed in the sonde, the measurement tool having at least one electrode operatively coupled to the analog output of the second digital-to-analog converter; providing a first digital code to the first digital-to-analog converter to determine the selectable amplitude; providing a second digital code to the second digital-to-analog converter to determine the selectable frequency; coupling a processor to the digital input of the first digital-to-analog converter to provide the first digital code; coupling a controller to the second digital-to-analog converter to provide the second digital code; coupling a low-pass filter to the analog output of the second digital-to-analog converter; coupling the analog output of the second digital-to-analog converter to an electrode; the downhole tool is suspended by a wireline; utilizing the electrode to inject a current generated by the downhole tool into the formation; providing a drill bit coupled to the drill string; rotating the drill bit so as to drill a bore hole within the earthen formation; and while rotating the drill bit, providing the first digital code to the first digital-to-analog converter and the a second digital code to the second digital-to-analog converter.

The Abstract of the disclosure is solely for providing the patent office and the public at large with a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

What is claimed:

1. A downhole tool comprising:
a housing having an electrode;
first and second digital-to-analog converters disposed in said housing and each having a digital input, a reference input, and an analog output, said analog output of said first digital-to-analog converter being operatively coupled to said reference input of said second digital-to-analog converter, said analog output of said second digital-to-analog converter being operatively coupled to said electrode; and
control circuitry coupled to the digital inputs of said first and second digital-to-analog converters.

2. The downhole tool of claim 1 wherein:
said control circuitry includes a controller coupled to the digital input of said second digital-to-analog converter for determining a frequency and a shape of a waveform characterizing a signal produced by said second digital-to-analog converter; and
said control circuitry includes a processor coupled to the digital input of said first digital-to-analog converter for controlling a voltage applied to the reference input of said second digital-to-analog converter thereby controlling the amplitude of said waveform.

3. The downhole tool of claim 2 wherein:
said controller is arranged to produce a sinusoidal waveform.

4. The downhole tool of claim 1 further comprising:
a low pass filter coupled between said analog output of said second digital-to-analog converter and said electrode.

5. The downhole tool of claim 1 wherein:
said downhole tool is a laterolog tool.

6. A system for generating a signal comprising:
first and second digital-to-analog converters disposed in said housing, each said digital-to-analog converter having a digital input, a reference input, and an analog output, said analog output of said first digital-to-analog converter being operatively coupled to said reference input of said second digital-to-analog converter;
a controller coupled to the digital input of said second digital-to-analog converter for determining a frequency and a shape of a waveform characterizing a signal produced by said second digital-to-analog converter; and
a processor coupled to the digital input of said first digital-to-analog converter for controlling a voltage applied to the reference input of said second digital-to-analog converter thereby controlling the amplitude of said waveform.

7. The system of claim 6 wherein:
said controller is independent of said processor.

8. The system of claim 6 further comprising:
a low pass filter operatively coupled to the analog output of said second digital-to-analog converter.

9. The system of claim 6, further comprising:
a drill string;
a drill bit disposed at the end of the drill string;
at least one measurement tool carried by the drill string, the measurement tool having at least one electrode operatively coupled to the analog output of said second digital-to-analog converter.

10. The system of claim 6, further comprising:
a logging cable;
a sonde attached to said logging cable;
at least one measurement tool disposed in said sonde, the measurement tool having at least one electrode operatively coupled to the analog output of said second digital-to-analog converter.

11. A method for generating a signal to be injected into an earthen formation comprising:
providing a downhole tool having first and second digital-to-analog converters, each digital-to-analog converter having a digital input, a reference input, and an analog output, said analog output of said first digital-to-analog converter being operatively coupled to said reference input of said second digital-to-analog converter; and
providing digital codes to the digital inputs of said first and second digital-to-analog converters to generate a signal characterized by a selectable frequency and a selectable amplitude.

12. The method of claim 11 further comprising:
providing a first digital code to said first digital-to-analog converter to determine said selectable amplitude; and
providing a second digital code to said second digital-to-analog converter to determine said selectable frequency.

13. The method of claim 12 further comprising:
coupling a processor to said digital input of said first digital-to-analog converter to provide said first digital code; and
coupling a controller to said second digital-to-analog converter to provide said second digital code.

14. The method of claim 11 further comprising:
coupling a low-pass filter to said analog output of said second digital-to-analog converter.

15. The method of claim 11 further comprising:
coupling said analog output of said second digital-to-analog converter to an electrode.

16. The method of claim 11 wherein:
said downhole tool is a laterolog tool.

17. The method of claim 11 wherein:
said downhole tool is suspended by a wireline.

18. The method of claim 15 further comprising:
utilizing the electrode to inject a current generated by the downhole tool into the formation.

19. The method of claim 18 further comprising:
providing a drill bit coupled to said drill string; and
rotating said drill bit so as to drill a bore hole within said earthen formation.

20. The method of claim 19 further comprising:
while rotating said drill bit, providing said first digital code to said first digital-to-analog converter and said a second digital code to said second digital-to-analog converter.
